(19) United States
(12) Patent Application Publication
(10) Pub. No.: US 2004/0227710 A1
(43) Pub. Date: Nov. 18, 2004

(54) Electro-optical panel, method for driving the same, electro-optical device,and electronic apparatus

(75) Inventors: Koji Shimizu, Matsumoto-shi (JP); Akihiko Ito, Tatsuno-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/764,476

(22) Filed: Jan. 27, 2004

(30) Foreign Application Priority Data
Mar. 6, 2003 (JP) 2003-060267

(51) Int. Cl. G09G 3/36

(52) U.S. Cl. 345/87; 345/90

(57) ABSTRACT

The invention reduces display unevenness between adjacent pixels. Signal-supplying lines have first input terminals T1a, T2a, and T3a at first ends. Selection signals are supplied to the first input terminals T1a to T3a. The signal-supplying lines are connected to terminals Ti1 to Ti3 through wiring lines. For individual demultiplexers, the distance from the terminal Ti1 to the first input terminal T1a, the distance from the terminal Ti2 to the first input terminal T2a, and the distance from the terminal Ti3 to the first input terminal T3a are equal. Therefore, the selection signals supplied to any one of the demultiplexers have the same waveform.

### BACKGROUND OF THE INVENTION

1. Field of Invention

The present invention relates to an electro-optical device, an electronic apparatus, and a method of driving an electro-optical panel.

2. Description of Related Art

Related art liquid crystal display panels that use liquid crystal as an electro-optic material include active matrix-type liquid crystal display panels. This type of liquid crystal display panel has a plurality of scanning lines, a plurality of data lines, and a matrix of pixels. The pixels are arranged corresponding to intersections between the scanning lines and the data lines. The pixels have thin film transistors (hereinafter “TFTs”) that function as switching elements, pixel electrodes, liquid crystal, and a counter electrode, which is opposite to the pixel electrodes, with the liquid crystal therebetween. Upon sequentially selecting the scanning lines, the TFTs connected to the selected scanning lines are switched on. Therefore, image signals supplied to the data lines are captured in the pixels, and an electrical charge is stored in the capacitance of the liquid crystal.

A driving circuit for the liquid crystal display panel includes a circuit to drive the scanning lines and a circuit to output image signals, which supply scanning signals and image signals to the scanning lines and the data lines at predetermined timing, and the like. Such a circuit to output image signals may generate an image signal every six data lines. Japanese Unexamined Patent Application Publication No. 2002-215117 (FIG. 2) discloses a technology to provide a six-to-one selecting circuit every six data lines and to supply an image signal to each data line by selecting one data line.

### SUMMARY OF THE INVENTION

Since the selecting circuit is composed of six switching elements, a selection signal is required to be supplied to each switching element to select a data line. The selection signal is usually supplied through some type of wiring line. In wiring lines, wiring resistance and stray capacitance are distributed. Thus, the wiring lines are composed of equivalent ladder low-pass filters. Accordingly, the waveform of the selection signal supplied to each switching element becomes distorted.

If the difference in waveforms of selection signals supplied to adjacent selecting circuits or adjacent switching elements is large, the on time of the switching elements, i.e., the time for which the data lines are selected, is different. The voltages written into pixels through data lines vary between adjacent pixels, resulting in a display-unevenness problem.

The present invention addresses the above and/or other circumstances, and provides an electro-optical device, an electronic apparatus, and a method of driving an electro-optical panel that reduce or eliminate display unevenness in adjacent pixels.

To address or solve the above, a first electro-optical device according to an aspect of the present invention includes a plurality of scanning lines; a plurality of data lines; a plurality of pixels arranged corresponding to intersections between the scanning lines and the data lines to form a matrix; a plurality of signal-supplying lines, first ends thereof being arranged close together and second ends thereof being arranged close together; a data-line selecting device having a plurality of selecting circuits, each selecting circuit supplying an image signal to one data line selected from a predetermined number of the data lines on the basis of a plurality of selection signals supplied through the plurality of signal-supplying lines; and a selection-signal supplying device to supply the plurality of selection signals from the first ends of the signal-supplying lines.

In accordance with this aspect of the present invention, the selection signals are supplied from the first ends of the signal-supplying lines so that the waveforms of the plurality of selection signals supplied to any one of the selecting circuits are substantially the same. Therefore, display unevenness in pixels connected to the adjacent data lines is reduced or eliminated. Preferably, the line widths of the signal-supplying lines may be the same or substantially the same since the resistance and the capacitance of wiring lines are dependent on the line widths of the wiring lines. Preferably, the signal-supplying lines may be formed in parallel with each other and the selecting circuits may be formed along the signal-supplying lines.

Preferably, the above-described first electro-optical device may further have an electro-optical panel having the plurality of scanning lines, the plurality of data lines, the plurality of pixels, the plurality of signal-supplying lines, and the data-line selecting device. The electro-optical panel is provided with a plurality of input terminals formed as the first ends of the plurality of signal-supplying lines. The selection-signal supplying device is provided outside of the electro-optical panel and supplies the plurality of selection signals to the plurality of input terminals. In this case, the first ends of the signal-supplying lines are the input terminals, and the selection signals are supplied through these input terminals.

A second electro-optical device according to an aspect of the present invention includes a plurality of scanning lines; a plurality of data lines; a plurality of pixels arranged corresponding to intersections between the scanning lines and the data lines to form a matrix; a plurality of signal-supplying lines, first ends thereof being arranged close together and second ends thereof being arranged close together; a data-line selecting device having a plurality of selecting circuits, each selecting circuit supplying an image signal to one data line selected from a predetermined number of the data lines on the basis of a plurality of selection signals supplied through the plurality of signal-supplying lines; and a selection-signal supplying device to supply the plurality of selection signals from the first ends and the second ends of the signal-supplying lines.

In accordance with this aspect of the invention, the selection signals are supplied from both ends of the signal-supplying lines so that waveforms of the plurality of selection signals supplied to any one of the selecting circuits are substantially the same. Therefore, display unevenness in pixels connected to the adjacent data lines is reduced or eliminated.

Preferably, the above-described second electro-optical device may further have an electro-optical panel having the plurality of scanning lines, the plurality of data lines, the plurality of pixels, the plurality of signal-supplying lines, and the data-line selecting device. A plurality of first input terminals are provided as the first ends of the plurality of signal-supplying lines and a plurality of second input terminals are provided as the second ends of the plurality of signal-supplying lines. The selection-signal supplying device is provided outside of the electro-optical panel and supplies the plurality of selection signals to the plurality of first input terminals and the plurality of second input terminals. In this case, both ends of the signal-supplying lines are the input terminals, and the selection signals are supplied through these input terminals.

Preferably, each of the selecting circuits may have a plurality of switching elements having first input-output terminals connected to the data lines, second input-output terminals connected to a node supplying the image signals, and control input terminals to which the selection signals are supplied. When the distance from the first ends or the second ends of the data lines to the selecting circuits are equal, the waveforms of the selection signals are substantially the same. Therefore, the time for which the switching elements are on does not vary between the adjacent switching elements, resulting in reduction or elimination of display unevenness and a great enhancement in image quality.

An electronic apparatus has the electro-optical device described above. Examples include a viewfinder used in a video camera, a mobile phone, a lap-top computer, and a video projector.

In a first method of driving an electro-optical panel according to an aspect of the present invention, the electro-optical panel has a plurality of scanning lines, a plurality of data lines, a plurality of pixels arranged corresponding to intersections between the scanning lines and the data lines to form a matrix, a plurality of signal-supplying lines, first ends of the signal-supplying lines being arranged close together and second ends of the signal-supplying lines being arranged close together, and a data-line selecting device having a plurality of selecting circuits, each selecting circuit supplying an image data signal to one data line selected from a predetermined number of the data lines on the basis of a plurality of selection signals supplied through the plurality of signal-supplying lines. The method includes supplying the plurality of selection signals from the first ends of the signal-supplying lines.

In a second method of driving an electro-optical panel according to an aspect of the present invention, the electro-optical panel has a plurality of scanning lines, a plurality of data lines, a plurality of pixels arranged corresponding to intersections between the scanning lines and the data lines to form a matrix, a plurality of signal-supplying lines, first ends of the signal-supplying lines being arranged close together and second ends of the signal-supplying lines being arranged close together, and a data-line selecting device having a plurality of selecting circuits, each selecting circuit supplying an image data signal to one data line selected from a predetermined number of the data lines on the basis of a plurality of selection signals supplied through the plurality of signal-supplying lines. The method includes supplying the plurality of selection signals from the first ends and the second ends of the signal-supplying lines.

### BRIEF DESCRIPTION OF THE DRAWINGS

FIG. 1 is a schematic illustrating the overall arrangement of a liquid crystal display device according to a first exemplary embodiment of the present invention;

FIG. 2 is a schematic illustrating the structure of a data-line selecting circuit used in the liquid crystal display device;

FIG. 3 is a schematic circuit diagram of a demultiplexer MPX1 used in the circuit;

FIG. 4 is a plan view illustrating the arrangement of signal-supplying lines L1 to L3 and a data-line selecting circuit 500 according to the first exemplary embodiment;

FIG. 5 is a schematic that shows waveforms of selection signals S1 to S3 according to the first exemplary embodiment;

FIG. 6 is a perspective view illustrating the mechanical structure of a liquid crystal display panel AA;

FIG. 7 is a partial sectional view showing the structure of the liquid crystal display panel AA;

FIG. 8 is a plan view illustrating the arrangement of signal-supplying lines L1 to L3 and a data-line selecting circuit 500 in a liquid crystal display device of a second exemplary embodiment;

FIG. 9 is a schematic that shows waveforms of selection signals S1 to S3 according to the second exemplary embodiment;

FIG. 10 is a sectional view illustrating a video projector as an example of an electronic apparatus including the liquid crystal display device;

FIG. 11 is a perspective view illustrating the structure of a personal computer as an example of an electronic apparatus including the liquid crystal display device; and

FIG. 12 is a perspective view illustrating the structure of a mobile phone as an example of an electronic apparatus including the liquid crystal display device.

### DETAILED DESCRIPTION OF PREFERRED EMBODIMENTS

<1. First Exemplary Embodiment>

An exemplary electro-optical device of the present invention is a liquid crystal display device that uses liquid crystal as the electro-optic material. The liquid crystal display device has a liquid crystal display panel AA as a main part. In the liquid crystal display panel AA, a device substrate with TFT switching elements and a facing substrate are spaced and aligned in such a manner that faces having electrodes of both substrates oppose each other. The space is filled with liquid crystal.

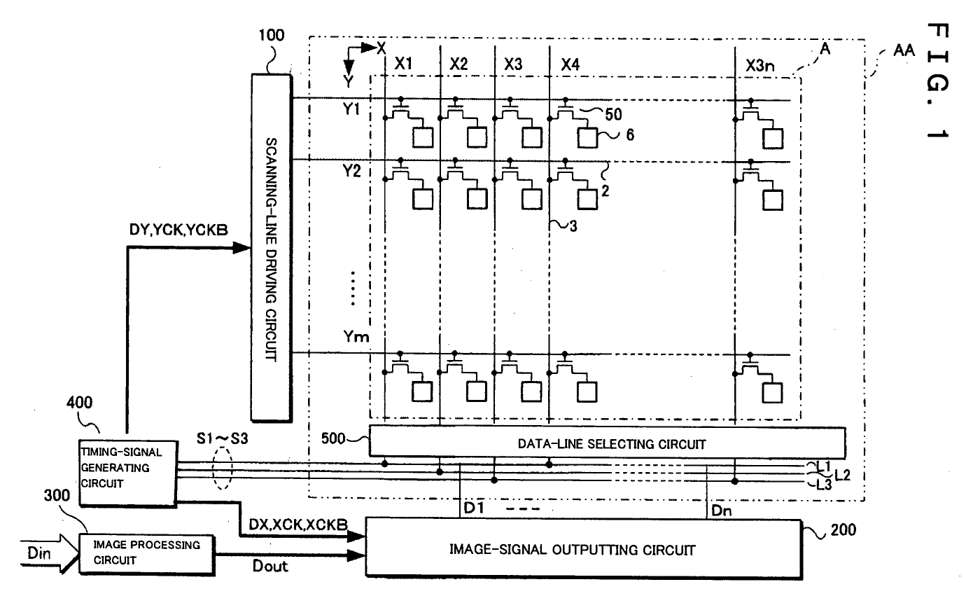

FIG. 1 is a schematic illustrating the overall structure of a liquid crystal display device according to a first exemplary embodiment of the present invention. The liquid crystal display device has the liquid crystal display panel AA, a scanning-line driving circuit 100, an image-signal outputting circuit 200, a timing-signal generating circuit 400, and an image processing circuit 300. The liquid crystal display panel AA has an image-displaying area A, a data-line selecting circuit 500, and signal-supplying lines L1 to L3 on the device substrate. The data-line selecting circuit 500 is composed of TFTs and is formed in the same process as TFTs of the image-displaying area A.

An input image data unit Din supplied to this liquid crystal display device may have, for example, the form of 3 bits in parallel. The timing-signal generating circuit 400 generates a Y clock signal YCK, an inverse Y clock signal YCKB, and a Y transfer start pulse DY in synchronism with an input image data unit Din and supplies them to the scanning-line driving circuit 100. The timing-signal generating circuit 400 generates an X clock signal XCK, an inverse X clock signal XCKB, and an X transfer start pulse DX in synchronism with the input image data unit Din and supplies them to image-signal outputting circuit 200. The timing-signal generating circuit 400 also generates and outputs various timing signals to control the image processing circuit 300.

The Y clock signal YCK is a signal one period of which equals two horizontal scanning periods. The inverse Y clock signal YCKB is the Y clock signal YCK inverted. The X clock signal XCK has a predetermined period: one period thereof is twice the selecting period of data lines 3. The inverse X clock signal XCKB is the X clock signal XCK inverted. The Y transfer start pulse DY indicates the start of selection of scanning lines 2, while the X transfer start pulse DX indicates the start of selection of the data lines 3.

The image processing circuit 300 generates an output image data unit Dout after performing gamma correction or the like considering the light transmission characteristics of the liquid crystal display panel AA on the input image data unit Din and supplies Dout to the image-signal outputting circuit 200. The image-signal outputting circuit 200 has one hundred and twenty output terminals and outputs image signals D1 to D120 from the respective output terminals. Signals to be supplied to three data lines 3 are time-division-multiplexed in individual image signals D1 to Dn.

On the image-displaying area A, m scanning lines 2 are arranged in parallel in the X direction and n groups of three data lines 3 are arranged in parallel in the Y direction. Around intersections of the scanning lines 2 and the data lines 3, gates of TFTs 50 are connected to the scanning lines 2; sources of the TFTs 50 are connected to the data lines 3; and drains of the TFTs 50 are connected to pixel electrodes 6. Pixels are composed of the pixel electrodes 6, a counter electrode (described below) disposed on the facing substrate, and the liquid crystal filled between both electrodes. Therefore, the pixels are arranged corresponding to the intersections between the scanning lines 2 and the data lines 3 to form a matrix. In the pixels of this exemplary embodiment, pixels to display red (R), green (G), and blue (B) are arranged in the form of stripes in the Y direction.

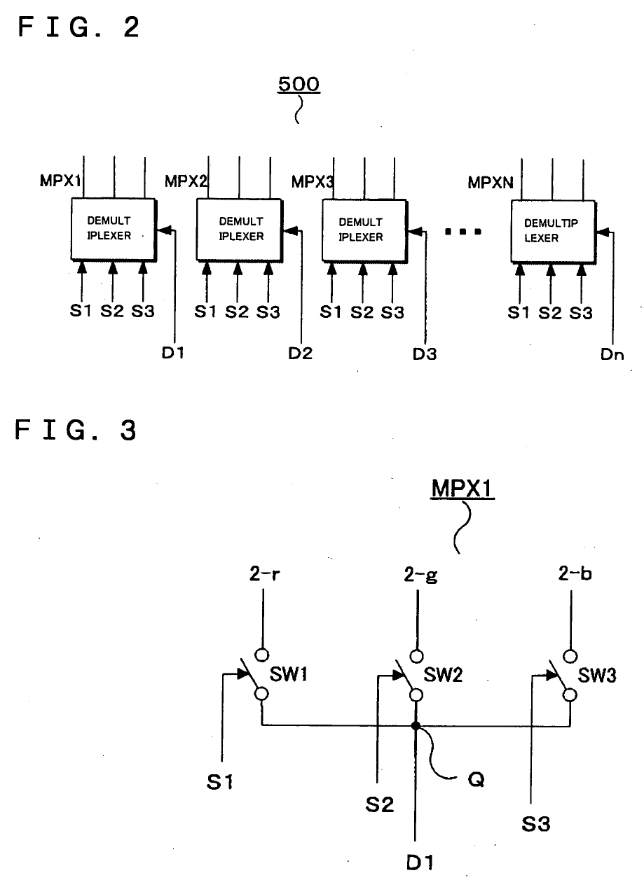

FIG. 2 is a schematic of the data-line selecting circuit 500. The data-line driving circuit has n demultiplexers (selecting circuits) MPX1 to MPXN. The image signals D1 to Dn are supplied to the demultiplexers MPX1 to MPXN, respectively. Each of the demultiplexers MPX1 to MPXN selects one of the data lines 3 on the basis of selection signals S1 to S3. The demultiplexers MPX1 to MPXN output the image signals D1 to Dn to the selected data lines 3.

FIG. 3 is a schematic circuit diagram of the demultiplexer MPX1. The other demultiplexers MPX2 to MPXN have the same structure as the demultiplexer MPX1. The demultiplexer MPX1 has three switching elements SW1 to SW3. Input-output terminals of the switching elements SW1 to SW3 are connected to the data lines 3 and the other input-output terminals thereof are connected to a node Q to which the image signal DI is supplied. In addition, the selection signals S1 to S3 are supplied to control input terminals of the switching elements SW1 to SW3. These switching elements SW1 to SW3 are composed of TFTs and are formed in the same process as the TFTs 50 of the image-displaying area A.

In the above-described arrangement, when the selection signal S1 becomes active, the switching element SW1 is on and the image signal D1 is supplied to a data line 2-r. When the selection signal S2 becomes active, the switching element SW2 is on and the image signal D1 is supplied to a data line 2-g. When the selection signal S3 becomes active, the switching element SW3 is on and the image signal D1 is supplied to a data line 2-b. Therefore, the image signal D1, in which a signal corresponding to each of the RGB components is time-division-multiplexed, is supplied to each of the predetermined data lines 2-r, 2-g, and 2-b.

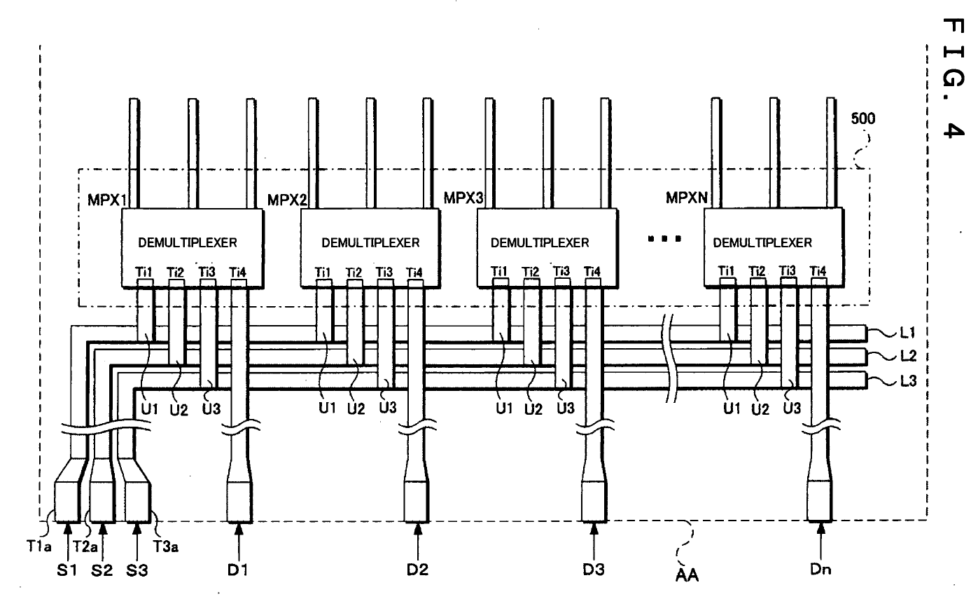

FIG. 4 is a plan view illustrating the arrangement of signal-supplying lines L1 to L3 and the data-line selecting circuit 500. Referring to this figure, the signal-supplying lines L1 to L3 are arranged in parallel and have the same width. First input terminals T1a to T3a are provided at first ends of the signal-supplying lines L1 to L3 and are arranged close together. The signal-supplying lines L1 to L3 are connected to terminals Ti1 to Ti3 through wiring lines U1 to U3. The wiring lines U1 to U3 are set to have the same width as the signal-supplying lines L1 to L3.

The selection signals S1 to S3 are supplied from the timing-signal generating circuit 400 to the first input terminals T1a to T3a. In each of the demultiplexers MPX1 to MPXN, the distance from the terminal Ti1 to the first input terminal T1a, the distance from the terminal Ti2 to the first input terminal T2a, and the distance from the terminal Ti3 to the first terminal T3a are equal. The width of each of the signal-supplying lines L1 to L3 is the same as that of the wiring lines U1 to U3.

In general, the resistance and the capacitance of wiring lines are determined by the length and the width of the wiring lines. In this exemplary embodiment, assuming that each of the lines from the first input terminals T1a, T2a, and T3a to the terminals Ti1, Ti2, and Ti3 is considered as a single wiring line, these wiring lines have the same length and width. Therefore, equivalent low-pass filters composed by these wiring lines have the same structure. Thus, the selection signals S1 to S3 supplied to any one of the demultiplexers have the same waveforms.

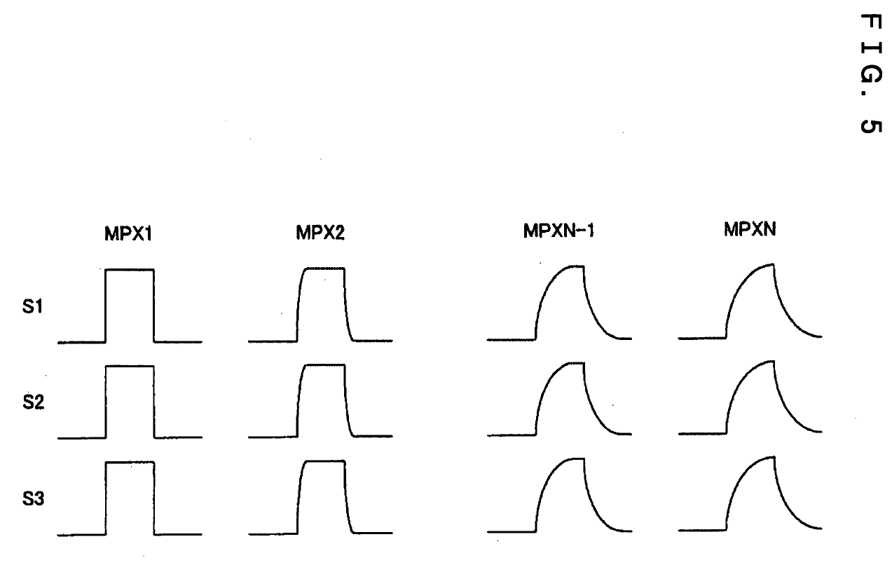

FIG. 5 shows waveforms of the selection signals S1 to S3 supplied to each of the demultiplexers. For example, the selection signals S1 to S3 supplied to the demultiplexer MPX2 have substantially the same waveforms. Therefore, the time for which the adjacent switching elements SW1 to SW3 are on can be substantially the same, thus enhancing the quality of display.

Since the time constant of each of the equivalent low-pass filters increases as the length of the wiring lines increases, the waveforms of the selection signals S1 to S3 become distorted in such a manner that the distortion becomes more noticeable from MPX1 to MPXN. However, the time constant of each of the low-pass filters varies rather gently, so it is merely a minor matter in terms of visual appearance.

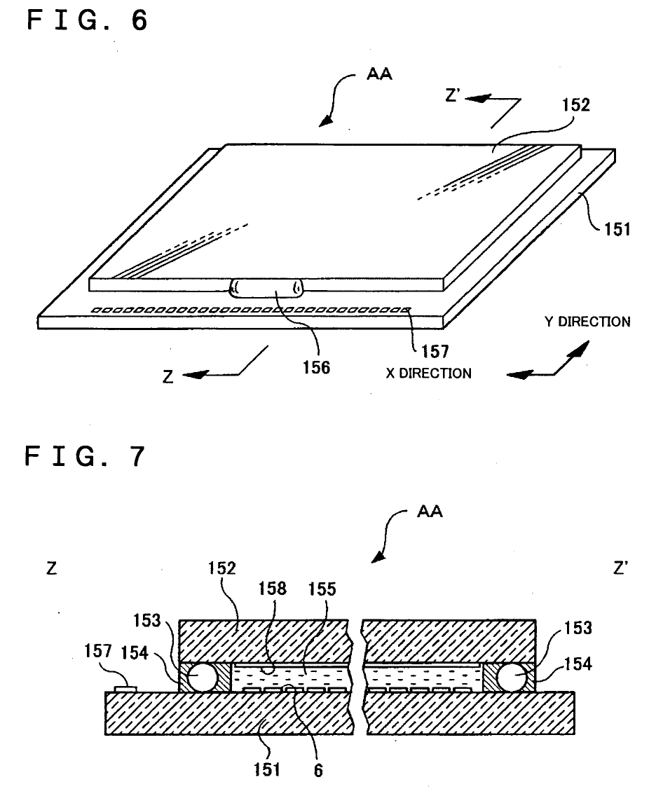

The mechanical structure of the above-described liquid crystal display panel AA is explained with reference to FIG. 6 and FIG. 7. FIG. 6 is a perspective view illustrating the structure of the liquid crystal display panel AA. FIG. 7 is a sectional view taken along plane Z-Z′ of FIG. 6.

As shown in these figures, the liquid crystal display panel AA has a structure in which a device substrate 151, such as a glass or semiconductor substrate, on which the pixel electrodes 6 are disposed, a transparent facing substrate 152, such as a glass substrate, on which a common electrode 158 is disposed, are spaced and sealed by a seal 154 containing spacers 153 in such a manner that faces having the electrodes of both substrates oppose each other and the space is filled with liquid crystal 155 as the electro-optic material. The seal 154 is disposed around the outer region of the facing substrate 152 and has a port to fill the space with the liquid crystal 155. This port is sealed with an end-sealing component 156 after the liquid crystal 155 is injected.

A plurality of connecting electrodes 157 are disposed outside of the seal 154 on one side of the opposing face of the device substrate 151 to input various signals, such as the image signals D1 to Dn from the image-signal outputting circuit 200 and the selection signals S1 to S3 from the timing-signal generating circuit 400. Peripheral circuits, such as the image-signal outputting circuit 200 and the scanning-line driving circuit 100, are mounted on a film using, for example, tape automated bonding (TAB) technology. Driving IC chips may be electrically and mechanically connected with an anisotropic conductive film (ACF) disposed at predetermined positions on the device substrate 151. Driving IC chips may be electrically and mechanically connected to predetermined positions with ACF using chip-on-glass (COG) technology, or alternatively, they may be disposed directly on the device substrate 151.

The common electrode 158 on the facing substrate 152 is electrically connected to the device substrate 151 by a conductive component disposed at least one corner of the four corners in sealed parts. A common electric potential VCOM is supplied through the conductive component. In accordance with the application of the liquid crystal display panel AA, on the facing substrate 152, firstly, a color filter having a striped arrangement, a mosaic arrangement, or a triangle arrangement may be provided; secondly, a black matrix may be provided, such as a metal material including chromium or nickel, or a resin black in which carbon, titanium, or the like is distributed in a photoresist; and thirdly, a back light to project light on the liquid crystal display panel AA may be provided. In the case of an application to a modulation of color and light, a color filter is not disposed and a black matrix is provided on the facing substrate 152.

In addition, rubbed alignment layers are provided on opposing faces of both the device substrate 151 and the facing substrate 152. By contrast, polarizers (not shown) corresponding to the direction of alignment are provided on the back sides of both substrates. If polymer dispersed liquid crystal, in which liquid-crystal particles are distributed in a polymer, is employed as the liquid crystal 155, the above-mentioned alignment layers and polarizers are not required, thereby increasing the utilization efficiency of light. This is advantageous in terms of increasing the brightness and reducing the power consumption.

<2. Second Exemplary Embodiment>

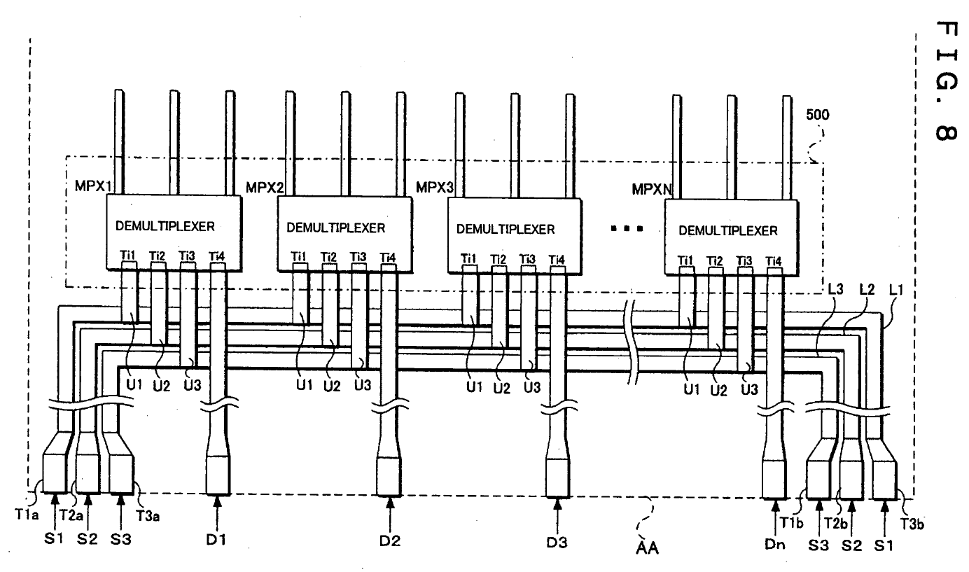

A liquid crystal display device of a second exemplary embodiment is similar to that of the first exemplary embodiment except for the supplying mode of selection signals S1 to S3 to signal-supplying lines L1 to L3. FIG. 8 is a plan view illustrating the arrangement of the signal-supplying lines L1 to L3 and a data-line selecting circuit 500 in a liquid crystal display device of the second exemplary embodiment.

In this exemplary embodiment, first input terminals T1a to T3a are provided at first ends of the signal-supplying lines L1 to L3 and second input terminals T1b to T3b are provided at second ends. The second input terminals T1b to T3b are arranged close together. The selection signals S1 to S3 are supplied from the first input terminals T1a to T3a and the second input terminals T1b to T3b.

In individual demultiplexers MPX1 to MPXN, the distance from a terminal Ti1 to the second input terminal T1b, the distance from a terminal Ti2 to the second input terminal T2b, and the distance from a terminal Ti3 to the second input terminal T3b are equal. The waveforms of the selection signals S1 to S3 supplied to any one of the demultiplexers are equal, as in the case of the first exemplary embodiment.

In the second exemplary embodiment, however, not only the first input terminals T1a to T3a but also the second input terminals T1b to T3b supply the selection signals S1 to S3. Therefore, the selection signals S1 to S3 supplied from both the input terminals T1a to T3a and T1b to T3b are combined at the terminals Ti1 to Ti3 in the individual demultiplexers MPX1 to MPXN.

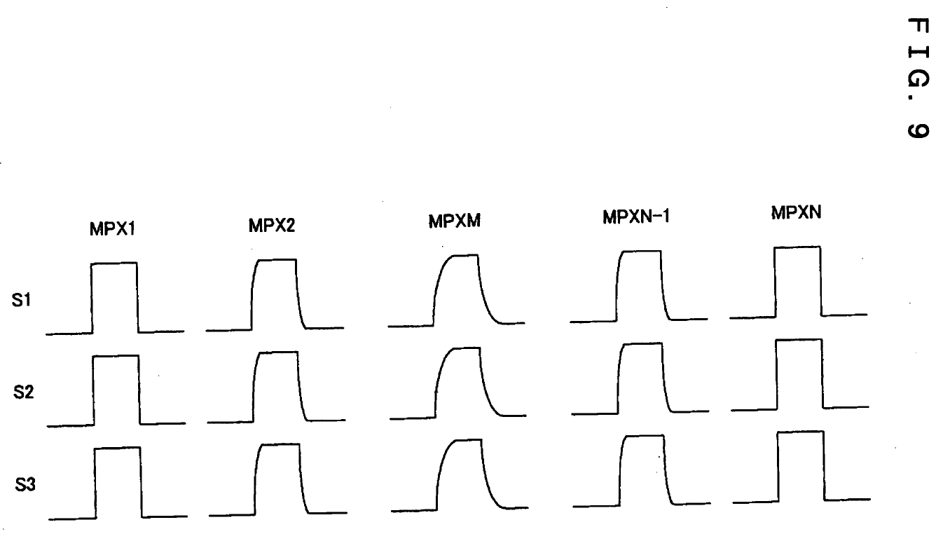

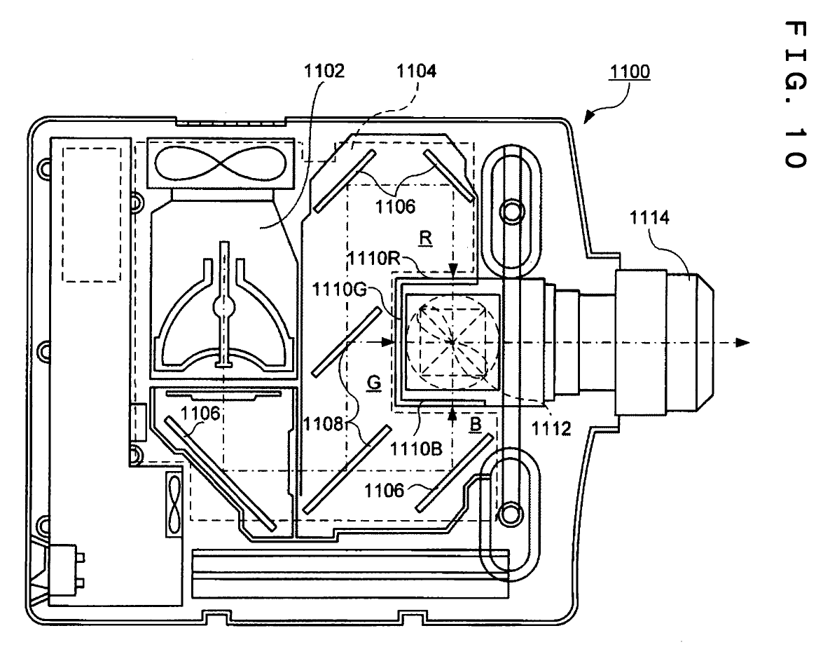

FIG. 9 shows waveforms of the selection signals S1 to S3 supplied to each of the demultiplexers. As is apparent from this figure, the waveforms of the selection signals S1 to S3 supplied to the demultiplexer MPX1 at the leftmost end are equal to those supplied to the demultiplexer MPXN at the rightmost end. Similarly, the waveforms of the selection signals S1 to S3 supplied to the demultiplexer MPX2 at the second position from the leftmost end are equal to those supplied to the demultiplexer MPXN-1 at the second position from the rightmost end.

A comparison of waveforms shown in FIG. 9 with that in FIG. 5 indicates that the waveforms of the second exemplary embodiment suffer less distortion and have similar shapes. This is because the length of the wiring lines can be short by supplying the selection signals S1 to S3 from both ends of the signal-supplying lines L1 to L3.

In accordance with the liquid crystal display device of the second exemplary embodiment, the waveforms of the selection signals S1 to S3 have smaller variations between the demultiplexers MPX1 to MPXN so that images are displayed more evenly on the entire screen.

<3. Exemplary Applications>

<3-1: Arrangement of the Device Substrate>

In the above-described exemplary embodiments, the device substrate 151 of the liquid crystal display panel AA is composed of a transparent insulating substrate, such as a glass substrate, on which silicon thin films are formed, and the switching elements (TFTs 50) of the pixels are composed of TFTs having sources, drains, and channels formed on the thin films. However, the present invention is not restricted to this arrangement.

For example, the device substrate 151 may be composed of a semiconductor substrate, and the switching elements or other elements of various circuits may be composed of insulated gate field effect transistors having sources, drains, and channels formed on the semiconductor substrate. In the case where the device substrate 151 is composed of a semiconductor substrate, aluminum pixel electrodes 6 are used to serve as a reflective panel since the semiconductor device substrate 151 cannot serve as a transparent display panel. Moreover, the device substrate 151 may be simply transparent and the pixel electrodes 6 may be of a reflective type.

The present invention is illustrated with active matrix-type liquid crystal display devices, but is not restricted to this arrangement. The present invention is applicable to passive-type display devices including super twisted nematic (STN) liquid crystal or the like. The present invention is also applicable to display devices including electroluminescent elements other than liquid crystal as the electro-optic material to perform display by the electro-optical effect. In other words, the present invention is applicable to all electro-optical devices having a structure similar to the above-described liquid crystal display devices.

<3-2: Exemplary Electronic Apparatuses>

Various exemplary electronic apparatuses adopting the above-described liquid crystal display devices are described below.

<3-2-1: Projector>

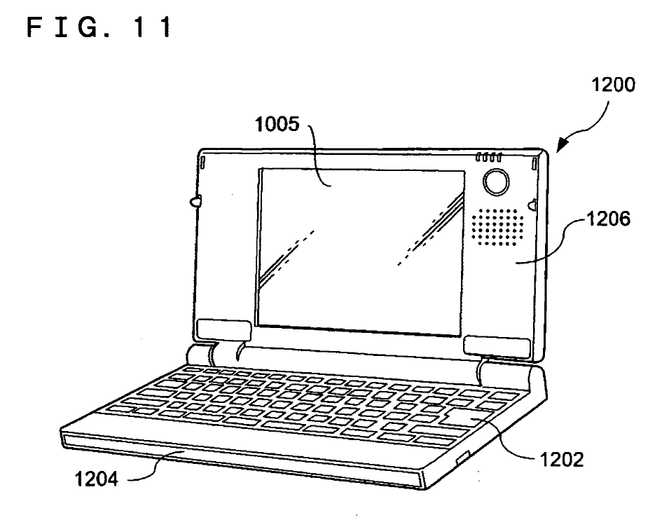

Firstly, a projector including this liquid crystal display device functioning as a light valve is described. FIG. 10 is a sectional view illustrating an example of the arrangement of the projector.

As shown in this figure, a lamp unit 1102 including a white light source, such as a halogen lamp, is provided inside of a projector 1100. Projecting light emitted from the lamp unit 1102 is separated into three primary colors, RGB, by four mirrors 1106 and two dichroic mirrors 1108 arranged in a light guide 1104 and enters liquid crystal display panels 1110R, 1110G, and 1110B, which act as light valves corresponding to each primary color.

The liquid crystal display panels 1110R, 1110G, and 1110B have the same structure as the above-described liquid crystal display panel AA and are respectively driven by primary color signals for R, G, and B, which are supplied from an image-signal processing circuit (not shown). Light modulated by these liquid crystal panels enters a dichroic prism 1112 from three directions. In the dichroic prism 1112, R light and B light are deflected at right angles and G light travels straight through. Images of these colors are combined and thus color images are projected on a screen or the like through a projecting lens 1114.

A display image formed through the liquid crystal panel 1110G must be inverted horizontally relative to display images formed through the liquid crystal display panels 1110R and 1110B.

The liquid crystal display panels 1110R, 1110G, and 1110B do not need color filters since the incident light corresponds to RGB due to the dichroic mirrors 1108.

<3-2-2: Mobile Computer>

An application of this liquid crystal display panel to a mobile personal computer is described below. FIG. 11 is a perspective view illustrating the structure of this personal computer. Referring to this figure, a computer 1200 has a main body 1204 including a keyboard 1202 and a liquid crystal display unit 1206. The liquid crystal display unit 1206 is composed by adding a back light to the back side of a liquid crystal display panel 1005 according to the present invention.

<3-2-3: Mobile Phone>

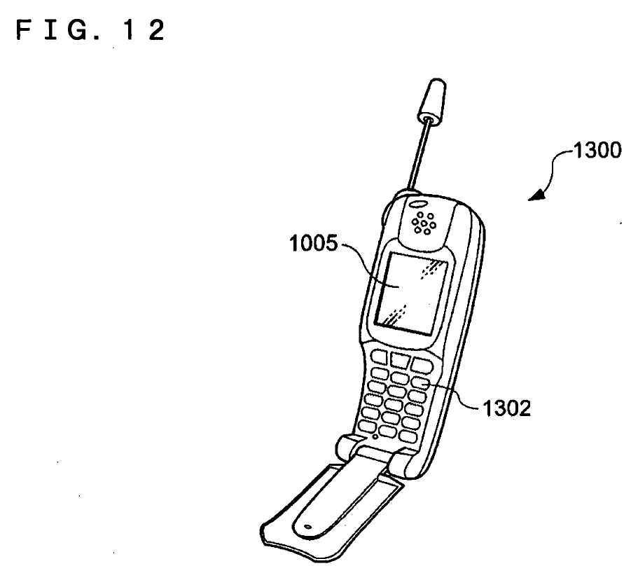

Further, an example applying this liquid crystal display panel to a mobile phone is described below. FIG. 12 is a perspective view illustrating the structure of this mobile phone. Referring to this figure, a mobile phone 1300 has a plurality of operating buttons 1302 and a reflective liquid crystal display panel 1005. The reflective liquid crystal display panel 1005 has a front light on the front face, as required.

Apart from the electronic apparatuses described with reference to FIG. 10 to FIG. 12, other exemplary applications include a liquid crystal television, a viewfinder or monitor-direct-view videotape recorder, a car navigation system, a pager, an electronic notepad, an electronic calculator, a word processor, a workstation, a videophone, a POS terminal, and a device having a touch panel, for example. The present invention is applicable to these and other various electronic apparatuses.

What is claimed is:

1. An electro-optical device, comprising:
a plurality of scanning lines;
a plurality of data lines;
a plurality of pixels arranged corresponding to intersections between the scanning lines and the data lines to form a matrix;
a plurality of signal-supplying lines having first ends that are arranged close together and second ends that are arranged close together;
a data-line selecting device having a plurality of selecting circuits, each selecting circuit supplying an image signal to one data line selected from a predetermined number of the data lines on the basis of a plurality of selection signals supplied through the plurality of signal-supplying lines; and
a selection-signal supplying device to supply the plurality of selection signals from the first ends of the signal-supplying lines.

2. The electro-optical device according to claim 1, further comprising:
an electro-optical panel having the plurality of scanning lines, the plurality of data lines, the plurality of pixels, the plurality of signal-supplying lines, and the data-line selecting device, and including a plurality of input terminals provided as the first ends of the plurality of signal-supplying lines;
the selection-signal supplying device being provided outside of the electro-optical panel and supplying the plurality of selection signals to the plurality of input terminals.

3. An electro-optical device, comprising:
a plurality of scanning lines;
a plurality of data lines;
a plurality of pixels arranged corresponding to intersections between the scanning lines and the data lines;
a plurality of signal-supplying lines having first ends that are arranged close together and second ends that are arranged close together;
a data-line selecting device having a plurality of selecting circuits, each selecting circuit supplying an image signal to one data line selected from a predetermined number of the data lines on the basis of a plurality of selection signals supplied through the plurality of signal-supplying lines; and
a selection-signal supplying device to supply the plurality of selection signals from the first ends and the second ends of the signal-supplying lines.

4. The electro-optical device according to claim 3, further comprising:
an electro-optical panel having the plurality of scanning lines, the plurality of data lines, the plurality of pixels, the plurality of signal-supplying lines, and the data-line selecting device, and including a plurality of first input terminals provided as the first ends of the plurality of signal-supplying lines and a plurality of second input terminals provided as the second ends of the plurality of signal-supplying lines;
the selection-signal supplying device being provided outside of the electro-optical panel and supplying the plurality of selection signals to the plurality of first input terminals and the plurality of second input terminals.

5. The electro-optical device according to claim 1, each of the selecting circuits having a plurality of switching elements having first input-output terminals connected to the data lines, second input-output terminals connected to a node supplying the image signals, and control input terminals to which the selection signals are supplied.

6. An electronic apparatus, comprising:
the electro-optical device according to claim 1.

7. A method of driving an electro-optical panel having a plurality of scanning lines, a plurality of data lines, a plurality of pixels arranged corresponding to intersections between the scanning lines and the data lines to form a matrix, a plurality of signal-supplying lines having first ends that are arranged close together and second ends that are-arranged close together, and a data-line selecting device having a plurality of selecting circuits, each selecting circuit supplying an image data signal to one data line selected from a predetermined number of the data lines on the basis of a plurality of selection signals supplied through the plurality of signal-supplying lines, the method comprising:
supplying the plurality of selection signals from the first ends of the signal-supplying lines.

8. A method of driving an electro-optical panel having a plurality of scanning lines, a plurality of data lines, a plurality of pixels arranged corresponding to intersections between the scanning lines and the data lines to form a matrix, a plurality of signal-supplying lines having first ends that are arranged close together and second ends that are arranged close together, and a data-line selecting device having a plurality of selecting circuits, each selecting circuit supplying an image data signal to one data line selected from a predetermined number of the data lines on the basis of a plurality of selection signals supplied through the plurality of signal-supplying lines, the method comprising:
supplying the plurality of selection signals from the first ends and the second ends of the signal-supplying lines.
